(19) United States
(12) Patent Application Publication
(10) Pub. No.: US 2026/0166924 A1
(43) Pub. Date: Jun. 18, 2026

(54) VEHICLE TYRE

(71) Applicant: Continental Reifen Deutschland GmbH, Hannover (DE)

(72) Inventors: Stefan Rittweger, Garbsen (DE); Juraj Jurco, Hannover (DE)

(21) Appl. No.: 18/707,863

(22) PCT Filed: Sep. 6, 2022
(86) PCT No.: PCT/DE2022/200205

§ 371 Date: May 6, 2024

(30) Foreign Application Priority Data
Nov. 8, 2021 (DE) 10 2021 212 509.3

(51) Int. Cl. B60C 13/00; B29D 30/06; B29D 30/72; B60C 13/02

(52) U.S. Cl. CPC B60C 13/001; B29D 30/0606; B29D 30/72; B60C 13/02; B29D 2030/0612; B29D 2030/726

(57) ABSTRACT

A vehicle tire, in particular a pneumatic vehicle tire, having sidewalls and a tread and having at least one hatching area on at least one of the sidewalls and/or on the tread wherein the hatching area has elongated hatching ribs, which run next to one another and have directions of longitudinal extent running parallel or largely parallel to one another. The vehicle tire is distinguished in that the hatching ribs have rib portions which follow one another in a zig-zag shape and together enclose alternately inner-corner and outer-corner regions, wherein a freely ending additional rib branches off respectively on the same side of the hatching ribs and respectively extends up from inner-corner regions, and wherein hatching ribs running next to one another are offset from one another with respect to their directions of longitudinal extent in such a way that the outer-corner regions and inner-corner regions of adjacent hatching ribs respectively lie opposite one another. The invention also relates to a vulcanizing mold and to a method for producing the pneumatic vehicle tire.

### CROSS-REFERENCE TO RELATED APPLICATIONS

The present application is a National Stage Application under 35 U.S.C. § 371 of International Patent Application No. PCT/DE 2022/200205 filed on Sep. 6, 2022, and claims priority from German Patent Application No. 10 2021 212 509.3 filed on Nov. 8, 2021, in the German Patent and Trademark Office, the disclosures of which are herein incorporated by reference in their entireties.

### TECHNICAL FIELD

The invention relates to a vehicle tire having sidewalls and a tread and having at least one hatching area on at least one of the sidewalls and/or on the tread, wherein the hatching area has elongate hatching ribs, which run next to one another and have directions of longitudinal extent running parallel or largely parallel to one another.

### BACKGROUND

Hatching areas are usually imprinted into the outside of the tire in the course of vulcanizing the tire by means of a molding vulcanizing mold, which has a negative contour of the relevant hatching area on one mold surface. A hatching area, or a surface element forming a structured hatching area, can be produced on an already vulcanized tire by material removal, by means of engraving or by an additive process.

Hatching areas formed on sidewalls of vehicle tires primarily have the task of providing a contrast to smooth surface regions present on sidewalls, shoulder flanks of the tire or groove flanks of grooves in the tread, special attention being paid to good visibility and identifiability, for example in order to optically emphasize inscriptions, pictorial elements, company logos, other identifiers and the like that are present on the sidewalls. The hatching area may be part of these elements or completely or partially surround or encircle them. Hatching areas also make it possible to conceal unevennesses on the tire sidewalls caused by construction. Embodiments of hatching areas on sidewalls with hatching ribs running next to one another are known, for example, from EP 2 502 758 A1 and DE 10 2008 010 486 A1.

The scattering of light on flanks of hatching ribs reduces the degree of reflection of the light on the surface of the tire, which changes the brightness effect of p the hatching area and usually makes the hatching area appear darker than substantially smooth surface regions that do not have hatching areas. Although in particular hatching areas consisting of hatching ribs running parallel to one another can be engraved very readily in the form of negative contours into a mold surface of a vulcanizing mold for the molding vulcanization of the vehicle tire, for example by means of a laser, and then stamped in the rubber material with good quality while the tire is being vulcanized, their contrast effect is greatly dependent on the direction of the light incidence. The contrast can therefore suddenly decrease at certain viewing angles.

### SUMMARY

The invention is therefore based on the object of selectively influencing, in particular increasing, the contrast effect of hatching areas with hatching ribs in all light situations and at all angles of light incidence, and in the process finding a good compromise between an improved contrast effect and effective producibility—with respect to the tire vulcanizing mold—at the same time.

This object is achieved by a vehicle tire as claimed in claim 1, a vulcanizing mold as claimed in claim 16, and a production method as claimed in claim 17.

The vehicle tire according to the invention is characterized in that the hatching ribs have rib portions which follow one another in a zig-zag shape and together enclose alternately inner-corner and outer-corner regions, wherein a freely ending additional rib branches off respectively on the same side of the hatching ribs and respectively extends up from inner-corner regions, and wherein hatching ribs running next to one another are offset from one another with respect to their directions of longitudinal extent in such a way that the outer-corner regions and inner-corner regions of adjacent hatching ribs respectively lie opposite one another.

The hatching ribs that run in a zig-zag shape according to the invention, together with the additional ribs, provide a multiplicity of rib flanks running in different directions, at which light incident from all possible directions is scattered, repeatedly reflected and absorbed in a way that creates a particularly high contrast effect. At all viewing angles, the hatching areas therefore appear to be particularly dark and to have a high contrast. In addition, shadow effects occur which assist a clear emphasis of the hatching area, especially on the black rubber of the vehicle tire.

A particularly good contrast effect caused by particularly advantageous reflection and absorption of incident light is assisted by a number of measures.

According to one of these measures, the additional ribs branch off exclusively at inner-corner regions of one side and respectively the same side of the hatching ribs and in particular at all the inner-corner regions of these sides.

In the case of a further feature which is advantageous in this respect, the additional ribs run parallel to one another, in particular in a straight line and at right angles to the direction of longitudinal extent of the hatching ribs.

A relatively small dimensioning of the hatching ribs and their additional ribs and also various distances contribute to a further particularly significant contrast effect. It is advantageous in this respect, for instance, when the additional ribs have a length of extent of 0.20 mm to 0.50 mm, preferably of 0.25 mm to 0.40 mm, particularly preferably of 0.25 mm to 0.32 mm.

As regards the dimensionings mentioned, it is advantageous when the mutually facing outer-corner regions of adjacent hatching ribs have a clear distance of 0.20 mm to 0.40 mm from one another and also when there is a distance of at least 0.50 mm and in particular up to 0.80 mm in the outer-corner regions of adjacent hatching ribs in the horizontal direction. The hatching ribs at such a close distance enable a particularly good contrast effect at all viewing angles.

In this connection, it is additionally advantageous when the rib portions adjoining one another at the inner-corner regions form a respective inner angle of 70° to 120° with one another, wherein preferably the inner angles of the hatching ribs of a hatching area are of equal magnitude.

The length of extent of the rib portions also contributes to particularly advantageous light scattering. The rib portions each have a length of extent of 0.20 mm to 0.40 mm, in particular 0.25 mm to 0.30 mm, wherein preferably the length of extent of the rib portions of the hatching ribs of a hatching area respectively are of equal magnitude.

It makes it easier to make the hatching-rib structure in mold surfaces of vulcanizing molds when corner edges are formed at inner-corner regions from which no additional ribs extend, and when the outer-corner regions are preferably flattened or rounded corner regions.

A certain self-cleaning of the hatching ribs on the tire outer surfaces is assisted in that the hatching ribs and/or the additional ribs have a height of 0.10 mm to 0.80 mm, preferably 0.20 mm to 0.50 mm, particularly preferably 0.25 mm to 0.35 mm at their highest point, and when the additional ribs preferably have a height which at least at their branching-off points is equal to the height of the hatching ribs.

In connection with the formation of the negative structures of the hatching ribs, it is also advantageous when, at their highest point, the hatching ribs and/or the additional ribs have a tip region which is in the form either of a narrow plateau, 0.05 mm to 0.10 mm wide, running over the length of extent of the rib portions or additional ribs, or of a rounding.

Another embodiment which assists scattering or absorption of incident light that emphasises the contrast effect consists in the hatching ribs and the additional ribs having lateral rib flanks, which slope in the direction of a hatching base on which the ribs are formed, and respectively run at an angle of up to 10°, in particular of 2° to 10°, preferably of 3° to 5°, to a perpendicular to the hatching base.

Further embodiments that are advantageous in this respect consist in at least one hatching rib and/or at least one additional rib having at least one rib flank which is convexly or concavely curved or has a convexly or concavely curved region and/or has a stepped or structured form or has a stepped or structured region.

The vulcanizing mold according to the invention for molding vulcanization of the vehicle tire has a mold surface which has a negative contour of a hatching area with elongate hatching ribs running next to one another and is characterized in that the negative contour has depressions that run in a zig-zag shape for forming hatching ribs having rib portions which follow one another in a zig-zag shape and have outer-corner regions and inner-corner regions, and, at the inner-corner regions, has further depressions for forming additional ribs on respectively the same sides of the hatching ribs, wherein the depressions that run in a zig-zag shape are offset with respect to one another in such a way that respectively an inner-corner region lies opposite an outer-corner region of the adjacent depression.

A vulcanizing mold formed in this way enables reliable production of the hatching areas on a vehicle tire. The associated negative contour can be reliably created by means of laser engraving and can be imprinted on the tire surface with high quality in the course of the vulcanizing process.

The method provided according to the invention for producing a vehicle tire according to the invention comprises at least the following steps:
a) engraving a negative contour of a hatching area into a mold surface of a vulcanizing mold for molding vulcanization of a vehicle tire by means of laser engraving, wherein the negative contour has depressions that run in a zig-zag shape for forming hatching ribs having rib portions which follow one another in a zig-zag shape and have outer-corner regions and inner-corner regions, and, at inner-corner regions, has further depressions for forming additional ribs on respectively the same sides of the hatching ribs,
   wherein the depressions that run in a zig-zag shape are offset with respect to one another in such a way that respectively an inner-corner region lies opposite an outer-corner region of the adjacent depression,
   b) providing a green tire and positioning the green tire in the vulcanizing mold,
   c) performing molding vulcanization of the green tire by means of the vulcanization mold, as a result of which a hatching area with hatching ribs and additional ribs is imprinted into an outer surface of the vehicle tire, in particular a sidewall and/or the tread of the vehicle tire.

It also holds true with respect to the method that at least one hatching area can be particularly reliably and exactly formed on the outer surface of a vehicle tire.

### DESCRIPTION OF THE DRAWINGS

Further features, advantages and details of the invention will now be described in more detail on the basis of the schematic drawing, which illustrates exemplary embodiments. In the drawing:

FIG. 1 shows a view of a vehicle tire with hatching areas,

FIG. 2 shows a greatly enlarged plan view of a detail of a hatching area,

FIG. 3 shows greatly enlarged oblique views of longitudinal portions of two hatching ribs of the hatching area, and

FIGS. 4a to 4e show embodiment variants of cross sections of hatching ribs.

### DETAILED DESCRIPTION

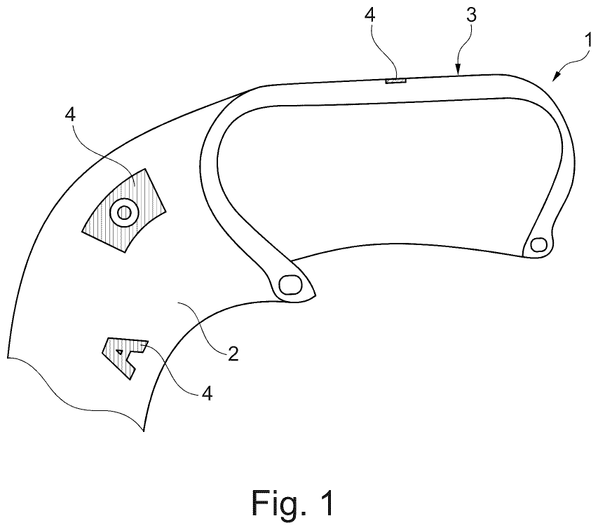

FIG. 1 schematically shows a portion of a vehicle tire 1 with sidewalls 2, a tread 3 and hatching areas 4 on the outer side of the one sidewall 2 and, indicated, on the tread 3. The vehicle tire is preferably a pneumatic vehicle tire, in particular for passenger cars, vans, SUVs, light trucks, utility vehicles, motorbikes, buses or bicycles. As is known, hatching areas 4 are surface elements that are made with any desired external form, for example as an image, a logo or text characters. Hatching areas 4 can also be formed on groove flanks and/or groove bases of grooves formed in the tread 3 or on the tread runout, that is to say on the shoulder flanks that run to the sidewalls outside the ground contact patch on the shoulder side.

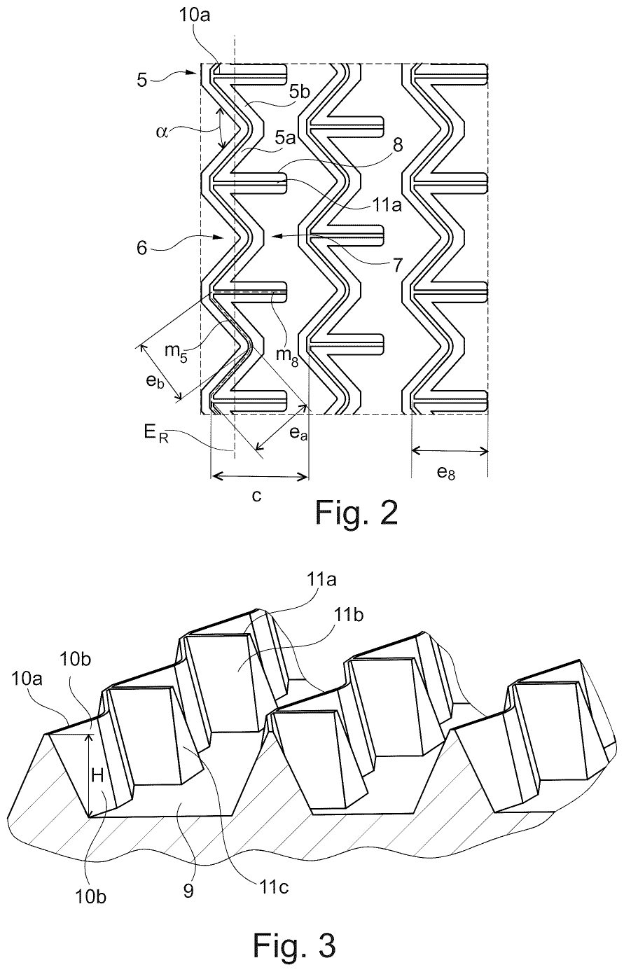

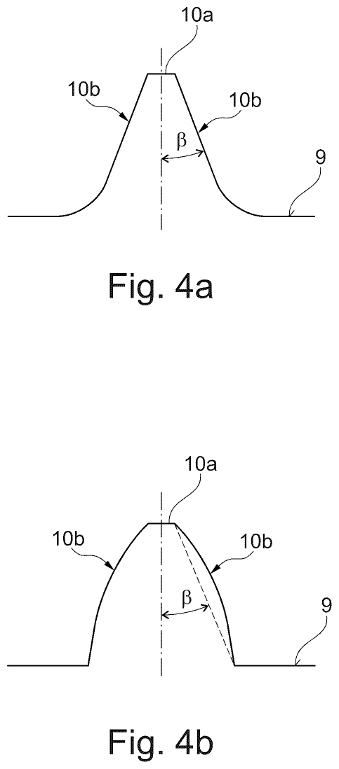

As shown in FIGS. 2 and 3, the hatching area 4 has elongate hatching ribs 5 which run next to one another and run in a regular zig-zag shape when seen in plan view. The hatching ribs 5 have a direction of longitudinal extent E_{R} which is a straight line in the embodiment shown, but can also run preferably overall and slightly arcuately or sinuously. As shown in particular in FIG. 2, each hatching rib 5 is composed of the rib portions 5a, 5b forming the zig-zag shape, which thus respectively alternately follow one another, wherein the rib portions 5a and the rib portions 5b respectively run parallel to one another or largely parallel to one another. Along a central middle line ms of the hatching ribs 5, the rib portions 5a have a length of extent eₐ, and the rib portions 5b have a length of extent e_{b}, wherein the lengths of extent eₐ and e_{b} respectively preferably have the same length of 0.20 mm to 0.40 mm, in particular 0.25 mm to 0.30 mm.

Owing to the zig-zag shape of the hatching ribs 5, inner-corner regions 6 and outer-corner regions 7 are located between the rib portions 5a, 5b that follow one another. The rib portions 5 a, 5 b form a respective inner angle α of 70° to 120° with one another at the inner-corner regions 6, and all the inner angles α of one and the same hatching rib 5 are preferably of the same magnitude. As shown in FIGS. 2 and 3, a respective additional rib 8 branches off from those inner-corner regions 6 located on the same side of the hatching ribs 5. Corner edges are preferably formed at inner-corner regions 6 at which no additional ribs 8 branch off, and the outer-corner regions 7 are in particular flattened or rounded corner regions.

All additional ribs 8 of a hatching rib 5 run parallel or largely parallel to one another and preferably have the same lengths of extent e₈. The length of extent es of the additional rib 8, ascertained from the middle line m₅ of the hatching rib 5 and along the central middle line m₈ of the additional rib 8, is 0.20 mm to 0.50 mm, preferably 0.25 mm to 0.40 mm, particularly preferably 0.25 mm to 0.32 mm.

The hatching ribs 5 running next to one another within a hatching area 4 are offset with respect to one another in their direction of longitudinal extent E_{R} in such a way that, respectively viewed transversely to the direction of longitudinal extent E_{R}, a rib portion 5a of the one hatching rib 5 runs next to a rib portion 5b of the adjacent hatching rib 5, and that the additional ribs 8 branching off from the inner-corner regions 6 respectively point in the direction toward an inner-corner region 6 of the adjacent hatching rib 5. The clear distance between the mutually facing outer-corner regions 7 of adjacent hatching ribs 5 is 0.20 mm to 0.40 mm. The “horizontally” measured distance c (FIG. 2) between the middle lines ms of the outer-corner regions 7 of adjacent hatching ribs 5 is at least 0.50 mm and in particular up to 0.80 mm.

The further design of a preferred embodiment of the hatching ribs 5 will now be explained in more detail with reference to FIG. 3. The hatching ribs 5 are located on a hatching base 9, which is for example the base of a flat depression formed in the sidewall 2 of the tire. The hatching ribs 5 are thus elevations which extend from the hatching base 9 or are formed thereon and the rib portions 5a, 5b of which, in the embodiment shown in FIG. 2, have a substantially triangular or triangle-like cross section with a tip region 10a and two rib flanks 10b, which slope in the direction of the hatching base 9 and respectively run at an acute angle β of up to 10°, in particular of 2° to 10°, preferably of 3° to 5°, to a perpendicular to the hatching base 9. The largest height H, ascertained perpendicularly to the hatching base 9, of the hatching ribs 5 is 0.10 mm to 0.80 mm, preferably 0.20 mm to 0.50 mm, particularly preferably 0.25 mm to 0.35 mm. The height H of a hatching rib 5 can also be the height ascertained along the longitudinal extent of this hatching rib 5. The aforementioned tip region 10a of the hatching ribs 5 may be in the form of a narrow plateau, 0.05 mm to 0.10 mm wide, which runs continuously over all of the rib portions 5a, 5b. In an alternative embodiment, the tip region 10a is a rounding between the upper ends of the rib flanks 10b.

In the embodiment variant shown in FIG. 3, the additional ribs 8 which extend or branch off from the inner-corner regions 6 have a triangular cross section which corresponds to the rib portions 5a, 5b, and therefore have a tip region 11a and rib flanks 11b which form the aforementioned angle β with a perpendicular to the hatching base 9. The height H of the additional ribs 8 corresponds to the height H of the hatching ribs 5. At their free ends, the additional ribs 8 have an end flank 11c, which, in the exemplary embodiment illustrated, is a largely planar surface which is a surface that slopes obliquely in the direction of the hatching base 9 at an angle of up to 5° or runs perpendicularly to the hatching base 9 and substantially parallel to the direction of extent E_{R}. In an alternative embodiment that is not shown, the end flank 11c has the overall form of a rounding between the rib flanks 11b.

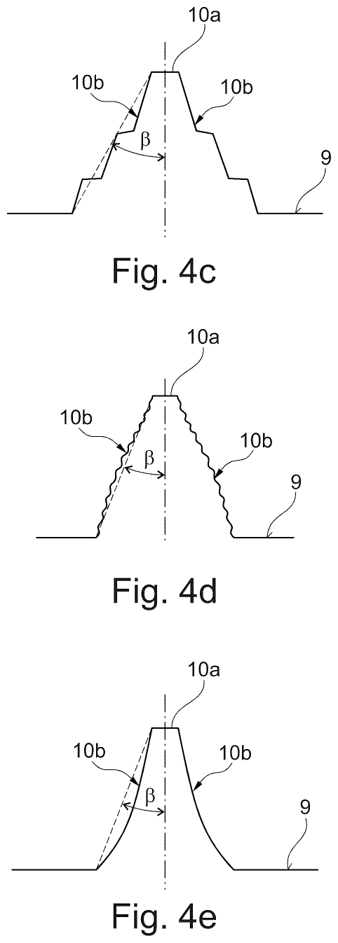

FIGS. 4a to 4e show further examples of cross sections of the hatching ribs 5 or their rib portions 5a, 5b and/or their additional ribs 8. The different cross-sectional shapes will be described with reference to a rib portion 5a. The cross sections illustrated are symmetrical with respect to a perpendicular to the hatching base 9. In all of the exemplary cross sections illustrated, the tip region 10a is flattened, thus provided with a narrow plateau. As an alternative, the tip region may be rounded and in this way be in the form of a transitional rounding between the two rib flanks 10b.

In the embodiment shown in FIG. 4a, the rib flanks 10b run at the already mentioned angle β relative to a perpendicular to the hatching base 9 although they do not transition into the hatching base 9 via a bend, but rather via a curvature or rounding. FIG. 4b shows a cross section in which the rib flanks 10b run with a convex curvature overall or at least over most of their extent. The transition to the hatching base 9 is respectively formed by a bend. The aforementioned angle β lies between a straight line connecting the end points of the rib flanks 10b.

FIG. 4c shows an embodiment of the cross section with stepped rib flanks 10b. Their angle of inclination β is between the two ends of the rib flanks 10 of a connecting straight line.

In the embodiment shown in FIG. 4d, the rib flanks 10d are structured, for example provided with a roughness, therefore with the smallest structures. The rib flanks 10d may overall have a convexly curved form or be substantially in the form of planar structured surfaces. FIG. 4e shows an embodiment in which the rib flanks 10d are concavely curved overall or over some of their extent, but adjoin the hatching base 9 via a bend.

Hatching areas 4 are produced on the surface of a vehicle tire 1, for instance on the sidewall 2, by molding vulcanization of the vehicle tire. To this end, the vulcanizing mold used has a mold surface which contains a negative contour of the hatching areas 4 to be provided.

The production of the vehicle tire 1 comprises in particular the following steps:
a) engraving a negative contour of a hatching area 4 into a mold surface of a vulcanizing mold for molding vulcanization of a vehicle tire 1 by means of laser engraving, wherein the negative contour has depressions that run in a zig-zag shape for forming hatching ribs 5 having rib portions 5a, 5b which follow one another in a zig-zag shape and have outer-corner regions and inner-corner regions, and, at inner-corner regions, has further depressions for forming additional ribs 8 on respectively the same sides of the hatching ribs 5,
   wherein the depressions that run in a zig-zag shape are offset with respect to one another in such a way that respectively an inner-corner region lies opposite an outer-corner region of the adjacent depression,
   b) providing a green tire and positioning the green tire in the vulcanizing mold,
   c) performing molding vulcanization of the green tire by means of the vulcanization mold, as a result of which a hatching area 4 with hatching ribs 5 and additional ribs 8 is imprinted into an outer surface of the vehicle tire, in particular a sidewall and/or the tread of the vehicle tire.

### LIST OF REFERENCE SIGNS

1 . . . Vehicle tire
2 . . . Sidewall
3 . . . Tread
4 . . . Hatching area
5 . . . Hatching rib
5a, 5b Rib portion
6 Inner-corner region
7 Outer-corner region
8 Additional rib
9 Hatching base
10a Tip region
10b Rib flank
11a Tip region
11b Additional rib flank
11c End flank
eₐ, e_{b}, e₈ Length of extent
E_{R} Direction of longitudinal extent
H Height
m₅, m₈ Central middle line
α, β Angle
a Distance

1. A vehicle tire comprising;
sidewalls;
a tread;
at least one hatching area on at least one of the sidewalls,
wherein the hatching area has elongate hatching ribs, which run next to one another and have directions of longitudinal extent running parallel or largely parallel to one another,
wherein the hatching ribs have rib portions which follow one another in a zig-zag shape and together enclose alternately inner-corner and outer-corner regions, wherein a freely ending additional rib branches off respectively on the same side of the hatching ribs and respectively extends up from inner-corner regions, and wherein hatching ribs running next to one another are offset from one another with respect to their directions of longitudinal extent in such a way that the outer-corner regions and inner-corner regions of adjacent hatching ribs respectively lie opposite one another.

2. The vehicle tire as claimed in claim 1, wherein the additional ribs branch off exclusively at inner-corner regions of one side and respectively the same side of the hatching ribs and in particular at all the inner-corner regions of these sides.

3. The vehicle tire of claim 1, wherein the additional ribs run parallel to one another, in particular in a straight line and at right angles to the direction of longitudinal extent of the hatching ribs.

4. The vehicle tire of claim 1, wherein the additional ribs have a length of extent of 0.20 mm to 0.50 mm, preferably of 0.25 mm to 0.40 mm, particularly preferably of 0.25 mm to 0.32 mm.

5. The vehicle tire of claim 1, wherein the mutually facing outer-corner regions of adjacent hatching ribs have a clear distance of 0.20 mm to 0.40 mm from one another.

6. The vehicle tire of claim 1, wherein there is a distance of at least 0.50 mm and in particular up to 0.80 mm in the outer-corner regions of adjacent hatching ribs in the horizontal direction.

7. The vehicle tire of claim 1, wherein the rib portions adjoining one another at the inner-corner regions form a respective inner angle of 70° to 120° with one another, wherein preferably the inner angles of the hatching ribs of a hatching area are of equal magnitude.

8. The vehicle tire of claim 1, wherein the rib portions have a respective length of extent of 0.20 mm to 0.40 mm, in particular 0.25 mm to 0.30 mm, wherein preferably the lengths of extent of the rib portions of the hatching ribs of a hatching area respectively are of equal magnitude.

9. The vehicle tire of claim 1, wherein corner edges are formed at inner-corner regions from which no additional ribs extend, wherein the outer-corner regions are preferably flattened or rounded corner regions.

10. The vehicle tire of claim 1, wherein the hatching ribs and/or the additional ribs have a height of 0.10 mm to 0.80 mm, preferably 0.20 mm to 0.50 mm, particularly preferably 0.25 mm to 0.35 mm at their highest point.

11. The vehicle tire of claim 1, wherein the additional ribs have a height which at least at their branching-off points is equal to the height of the hatching ribs

12. The vehicle tire of claim 1, wherein, at their highest point, the hatching ribs (and/or the additional ribs have a tip region which is in the form either of a narrow plateau, 0.05 mm to 0.10 mm wide, running over the length of extent of the rib portions or additional ribs or of a rounding.

13. The vehicle tire of claim 1, wherein the hatching ribs and the additional ribs have lateral rib flanks, which slope in the direction of a hatching base on which the ribs (§ are formed, and respectively run at an angle of up to 10°, in particular of 2° to 10°, preferably of 3° to 5°, to a perpendicular to the hatching base.

14. The vehicle tire of claim 1, wherein at least one hatching rib and/or at least one additional rib has at least one rib flank which is convexly or concavely curved or has a convexly or concavely curved region.

15. The vehicle tire of claim 1, wherein at least one hatching rib of the hatching area and/or at least one additional rib has at least one rib flank, has a stepped or structured form or has a stepped or structured region.

16. A vulcanizing mold for molding vulcanization of a vehicle tire, the mold comprising:
a mold surface which has a negative contour of a hatching area with elongate hatching ribs running next to one another,
the negative contour has depressions that run in a zig-zag shape for forming hatching ribs having rib portions which follow one another in a zig-zag shape and have outer-corner regions and inner-corner regions, and, at inner-corner regions, has further depressions for forming additional ribs on respectively the same sides of the hatching ribs,
wherein the depressions that run in a zig-zag shape are offset with respect to one another in such a way that respectively an inner-corner region lies opposite an outer-corner region of the adjacent depression.

17. A method for producing a vehicle tire, the method comprising:
engraving a negative contour of a hatching area into a mold surface of a vulcanizing mold for molding vulcanization of a vehicle tire by laser engraving, wherein the negative contour has depressions that run in a zig-zag shape for forming hatching ribs having rib portions which follow one another in a zig-zag shape and have outer-corner regions and inner-corner regions, and, at inner-corner regions, has further depressions for forming additional ribs on respectively the same sides of the hatching ribs,
wherein the depressions that run in a zig-zag shape are offset with respect to one another in such a way that respectively an inner-corner region lies opposite an outer-corner region of the adjacent depression,
providing a green tire and positioning the green tire in the vulcanizing mold,
performing molding vulcanization of the green tire by the vulcanization mold, as a result of which a hatching area with hatching ribs and additional ribs is imprinted into a sidewall and/or the tread of the vehicle tire.
